(19) United States
(12) Patent Application Publication
(10) Pub. No.: US 2005/0122414 A1
(43) Pub. Date: Jun. 9, 2005

(54) Digital camera system and method for maximizing television viewing area

(76) Inventors: James S. Voss, Fort Collins, CO (US); James W. Owens, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/732,872

(22) Filed: Dec. 9, 2003

(51) Int. Cl. H04N 17/00; H04N 17/02; H04N 5/222; G09G 5/02

(52) U.S. Cl. 348/333.01; 348/189; 348/370; 345/698

(57) ABSTRACT

A digital camera system and method that automatically maximizes television viewing area when a television is used to view images stored in or transferred from a digital camera. A test signal or image comprising a beacon is output from the digital camera and is displayed on a television screen. A user points the camera at the television. Firmware that runs on the digital camera moves the test signal and beacon horizontally and vertically towards respective edges of the television screen until the beacon is lost at each edge, and determines or calculates how much viewing area is available on the television screen. The autocalibration firmware then automatically adjusts the size of images sent from the digital camera to the television to maximize the viewing area on the television while minimizing cropping or clipping of the images.

### TECHNICAL FIELD

The present invention relates generally to digital cameras and methods.

### BACKGROUND

Digital cameras certainly have come of age when it comes to capturing and instantly reviewing photographs. More and more however, digital cameras are often used as a sharing device for showing pictures stored in the camera with friends and family. Many times this is done using a video output port of the camera and a conventional television.

The television signal is generally much larger than that displayed on the television. There are large borders across the top, bottom, left and right of the television that are not displayed. The television signal is on the order of 1700 pixels wide, while only 600 pixels are displayed. Due to calibration issues, the 600 pixels can vary such that the television displays 700 or 500 pixels, for example. Thus, the number of pixels that are displayed varies. The same thing occurs with the top and bottom borders of the television.

Conventional solutions simply output a television signal that is “nearly” guaranteed to be larger than the viewing area, and then centers this image within the television video frame. This causes clipping to occur and loss of viewable image area.

It would be desirable to maximize the viewing experience when a digital camera is coupled to a television in a manner that maximizes the viewing area of the television.

### SUMMARY OF THE INVENTION

The present invention provides for a digital camera system and method that automatically maximizes television viewing area when a television is used to view images stored in or transferred from a digital camera. In an embodiment of the present invention, a test signal or image comprising a beacon is output from the digital camera and is displayed on a television screen. A user points the camera at the television.

Firmware that runs on the digital camera moves the test signal and beacon horizontally and vertically towards respective edges of the television screen until the beacon is lost at each edge, and determines or calculates how much viewing area is available on the television screen. The autocalibration firmware then automatically adjusts the size of images sent from the digital camera to the television to maximize the viewing area on the television while minimizing cropping or clipping of the images.

### BRIEF DESCRIPTION OF THE DRAWINGS

The various features and advantages of embodiments of the present invention may be more readily understood with reference to the following detailed description taken in conjunction with the accompanying drawings, wherein like reference numerals designate like structural elements, and in which:

FIGS. 1a and 1b are rear and front views, respectively, of an exemplary digital camera that may be used in a system in accordance with the principles of the present invention;

FIG. 2 illustrates an exemplary system in accordance with the principles of the present invention; and

FIG. 3 illustrates an exemplary method in accordance with the principles of the present invention.

### DETAILED DESCRIPTION

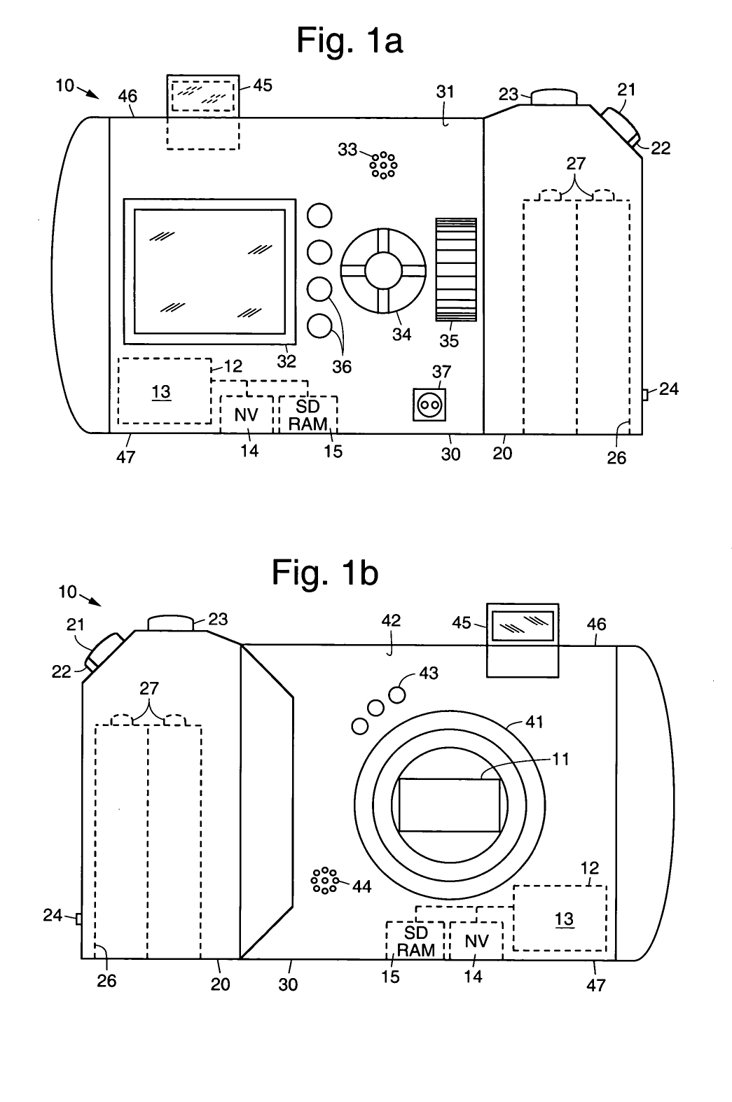

Referring to the drawing figures, FIGS. 1a and 1b are rear and front views, respectively, of an exemplary digital camera 10 implemented in accordance with the principles of the present invention. As is shown in FIGS. 1a and 1b, the exemplary digital camera 10 comprises a handgrip section 20 and a body section 30. The handgrip section 20 includes a power button 21 or switch 21 having a lock latch 22, a record button 23, a strap connection 24, and a battery compartment 26 for housing batteries 27. The batteries may be inserted into the battery compartment 26 through an opening adjacent a bottom surface 47 of the digital camera 10.

As is shown in FIG. 1a, a rear surface 31 of the body section 30 comprises a liquid crystal display (LCD) 32 or viewfinder 32, a rear microphone 33, a joystick pad 34, a zoom control dial 35, a plurality of buttons 36 for setting functions of the camera 10 and a video output port 37 for downloading images to a computer, for example. As is shown in FIG. 1b, a zoom lens 41 extends from a front surface 42 of the digital camera 10. A metering element 43 and front microphone 44 are disposed on the front surface 42 of the digital camera 10. A pop-up flash unit 45 is disposed adjacent a top surface 46 of the digital camera 10.

An image sensor 11 is coupled to processing circuitry 12 (illustrated using dashed lines) that are housed within the body section 30, for example. An exemplary embodiment of the processing circuitry 12 comprises a microcontroller (μC) 12 or central processing unit (CPU) 12. The (μC 12 or CPU 12 is coupled to a nonvolatile (NV) storage device 14, and a high speed (volatile) storage device 15, such as synchronous dynamic random access memory (SDRAM) 15, for example.

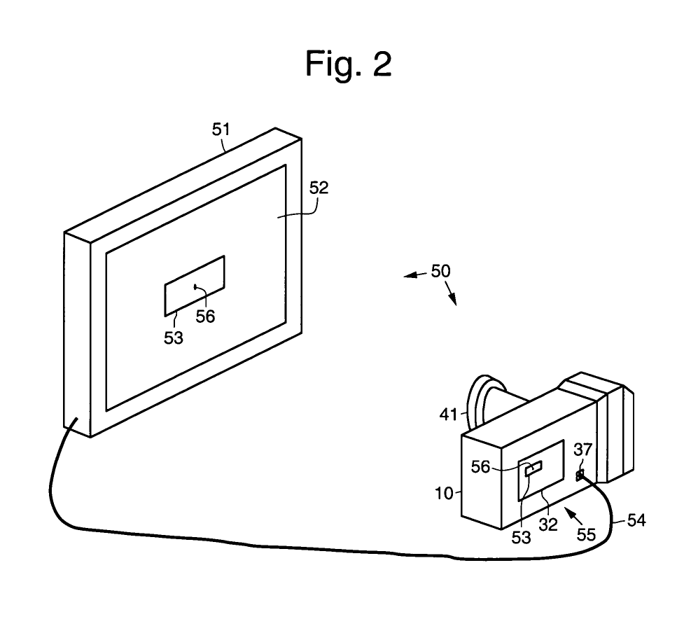

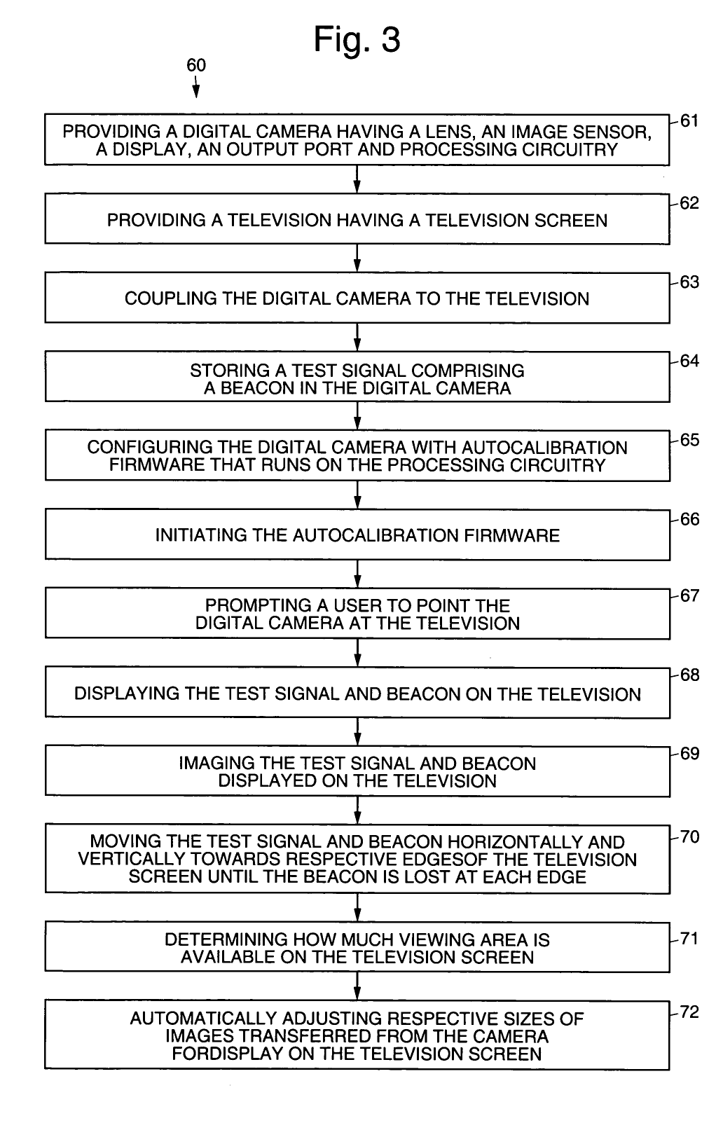

The processing circuitry 12 (microcontroller (μC) 12 or CPU 12) in the digital camera 10, embodies firmware 13 comprising an autocalibration algorithm 13 in accordance with the principles of the present invention. This will be discussed in more detail with reference to FIGS. 2 and 3.

Referring now to FIG. 2, it illustrates an exemplary system 50 in accordance with the principles of the present invention. The exemplary system 50 comprises a digital camera 10, such as the digital camera 10 discussed with reference to FIGS. 1a and 1b, for example, that is coupled to a television 51. The television 51 has a screen 52. The digital camera 10 is coupled from its video output port 37 by way of a cable 54, such as a coaxial cable or composite video cable, for example, to the television 51. A video test signal 53 or image 53 comprising a beacon 56 is stored in the digital camera 10, such as in the nonvolatile storage device 14, for example.

In accordance with the present invention, the digital camera 10 includes a user interface 55 implemented using the autocalibration firmware 13 (or software algorithm 13) that runs on the processing circuitry 12 (microcontroller (μC) 12 or CPU 12). The autocalibration firmware 13 is configured to automatically maximize television viewing area on the screen 52 when viewing images stored or transferred from the digital camera 10 to the television 51.

The firmware 13, by way of the user interface 55, prompts the user to point the digital camera 10 at the television 51. This may be accomplished by directing the user to point the digital camera 10 substantially straight at the television to avoid potential problems relating to angular issues. The firmware 13 on the digital camera 10 outputs a test signal 53 by way of the output port 37 to the television 51, which is displayed on the television screen 52. The test signal 53 comprises a beacon 56 that is recognizable by the firmware 13. Once pointed at the television 51, the lens 41 and image sensor 11 views the test signal 53 and beacon 56 displayed on the television screen 52. The output of the image sensor 11 is processed by the firmware 13.

The firmware 13 automatically adjusts the video signal output to the television 51 until an optimal image viewing area of the displayed image has been achieved. To achieve this, the firmware 13 performs a process that slides the test signal 53 to the left of the television screen 52, for example, and determines at which point it loses the beacon 56 in the television signal. The firmware repeats this process for the right side, the top side, and the bottom side of the television screen 52.

Once these operations are completed, the firmware 13 determines or calculates how much viewing area is available on the television screen 52, which is related to the locations at which the beacon 56 is lost relative to the four sides of the television screen 52. The firmware 13 then adjusts the sizes of the images that are transferred from the camera 10 and displayed on the television screen 52 to provide for the maximum viewing area while minimizing cropping or clipping of the images. To accomplish this, the resolution of the transferred images are adjusted to match the resolution of the television screen 52.

By way of example, the present invention may be used to adjust the viewing areas of a high definition television (HDTV) having a 16:9 display format or a standard television (NTSC) having a 4:3 display format.

Some CRT displays used with personal computers have buttons on the front panel that allow the user to set the size of the screen to occupy the entire visible area, for example. While this technique is used with personal computer displays, it has not heretofore been used as a feature that available with digital cameras 10. The present invention may be used to implement this feature by providing firmware 13 that displays a menu, or buttons, for example, by way of the user interface 55 that allow the user to selectively adjust the horizontal and vertical size of the displayed image. This technique may also be used to adjust the television for HDTV and NTSC display formats.

For the purposes of completeness, FIG. 3 illustrates an exemplary method 60 in accordance with the principles of the present invention. The exemplary method 60 comprises the following steps.

A digital camera 10 is provided 61 that comprises a lens 41, an image sensor 11, a display 32, a video output port 37, and processing circuitry 12. A television 51 having a screen 52 is provided 62. The digital camera 10 is coupled 63 to a television 51, such as by using the output port 37 and a cable 54, for example. A test signal 53 comprising a beacon 56 is stored 64 in the digital camera 10.

The digital camera 10 is configured 65 with autocalibration firmware 13 that runs on the processing circuitry 12. When initiated 66, the autocalibration firmware 13 prompts 67 the user to point the digital camera 10 at the television 51, displays 68 the test signal 53 on the television 51, processes 69 the test signal 53 displayed on the television 51 that is imaged the image sensor 11.

The autocalibration firmware 13 moves 70 the test signal 53 and beacon 56 horizontally and vertically towards respective edges of the display screen 52 until the beacon 56 is lost at each edge, and determines 71 or calculates 71 how much viewing area is available on the television screen 52. The autocalibration firmware 13 then automatically adjusts 72 the size of images sent from the digital camera 10 to the television 51 to maximize the viewing area on the television 51 while minimizing cropping or clipping of the images.

The present invention solves the problem of varying television viewing areas. By using the present invention, the digital camera 10 automatically determines where the viewable limits of the television 51 are located and then calculates the correct locations within an analog television signal that maximizes the displayed picture with minimal cropping or clipping. The present invention thus maximizes the viewing experience when using a television 51 to display images stored in a digital camera 10 in a manner that maximizes the usable area of the television 51.

Thus, digital cameras and methods that automatically maximize television viewing area for images and viewed on the television have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

1. A system comprising:
a digital camera that comprises a lens, an image sensor, a display, a video output port for coupling the camera to a television having a television display screen, and processing circuitry;
a test signal comprising a beacon stored in the digital camera; and
autocalibration firmware that runs on the processing circuitry and when the camera is coupled to a television, prompts the user to point the digital camera at the television display screen, displays the test signal and beacon on the television display screen, images the test signal and beacon displayed on the television display screen, moves the test signal and beacon horizontally and vertically towards respective edges of the television display screen until the beacon is lost at each edge, determines how much viewing area is available on the television display screen, and automatically adjusts the sizes of the images transferred from the camera for display on the television display screen to provide for the maximum viewing area while minimizing cropping or clipping of the images.

2. The system recited in claim 1, wherein the autocalibration firmware comprises a user interface that allows the user to selectively adjust the horizontal and vertical size of the displayed image.

3. The system recited in claim 2, wherein the television display screen comprises a 16:9 HDTV television display screen.

4. The system recited in claim 2, wherein the television display screen comprises a 4:3 NTSC television display screen.

5. The system recited in claim 2, wherein the user interface comprises a menu.

6. The system recited in claim 2, wherein the user interface comprises buttons.

7. A method comprising the steps of;
providing a digital camera that comprises a lens, an image sensor, a display, a video output port for coupling the camera to a television, and processing circuitry;
providing a television having a television display screen;
coupling the digital camera to the television;
storing a test signal comprising a beacon in the digital camera;
configuring the digital camera with autocalibration firmware that runs on the processing circuitry;
initiating the autocalibration firmware;
prompting a user to point the digital camera at the television display screen;
displaying the test signal and beacon on the television display screen;
viewing on the camera display the test signal and beacon displayed on the television display screen;
moving the test signal and beacon horizontally and vertically towards respective edges of the television display screen until the beacon is lost at each edge;
determining how much viewing area is available on the television display screen; and
automatically adjusting respective sizes of images transferred from the camera for display on the television display screen to provide for the maximum viewing area while minimizing cropping or clipping of the images.

8. The method recited in claim 7 wherein the autocalibration firmware comprises a user interface that allow the user to selectively adjust the horizontal and vertical size of the displayed image.

9. The method recited in claim 8, wherein the television display screen comprises a 16:9 HDTV television display screen.

10. The method recited in claim 8, wherein the television display screen comprises a 4:3 NTSC television display screen.

11. The method recited in claim 8, wherein the user interface comprises a menu.

12. The method recited in claim 8, wherein the user interface comprises buttons.
